(19) United States
(12) Patent Application Publication
(10) Pub. No.: US 2008/0079920 A1
(43) Pub. Date: Apr. 3, 2008

(54) Wafer exposure device and method

(76) Inventors: Heiko Hommen, Dresden (DE); Norman Birnstein, Dresden (DE); Karl Schumacher, Radebeul (DE); Jens Staecker, Dresden (DE)

Correspondence Address: SLATER & MATSIL LLP, 17950 PRESTON ROAD, SUITE 1000, DALLAS, TX, 75252, US

(21) Appl. No.: 11/541,400

(22) Filed: Sep. 29, 2006

(51) Int. Cl. G03B 27/52

(52) U.S. Cl. 355/55; 355/53

(57) ABSTRACT

A wafer exposure device includes a wafer stage. An optical exposure system exposes a wafer on the wafer stage. A sensor block measures a distance to a wafer provided on the wafer stage. The sensor block includes a plurality of height level sensors. Each height level sensor measures and outputs height level values. The wafer exposure device compares with one another the measured height level values outputted by respective height level sensors. The wafer exposure device calculates individual sensor position offset values to be attributed to the individual height level sensors. The wafer exposure device corrects the measured height level values output by the respective height level sensors using the calculated sensor position offset values of the respective height level sensor.

### TECHNICAL FIELD

The invention is directed to the field of semiconductor manufacture and more particularly to a wafer exposure devices and to methods for measuring a distance to a wafer arranged in a wafer exposure device. The invention in particular is directed to the field of wafer leveling in a lithographic exposure device.

### BACKGROUND

In the field of semiconductor manufacture, integrated circuits are produced on wafers or semiconductor substrates, like silicon substrates. The wafers are subjected to a plurality of processing steps, some of the processing steps comprising lithographic exposure of the wafer using a lithographic exposure device. Typically, a reticle is projected onto the wafer, thereby transferring mask patterns of the reticle onto the wafer (that is, onto a layer provided on the wafer and to be patterned lithographically. In most cases, a radiation-sensitive layer like a resist layer is provided on the substrate or on another layer (arranged on above substrate but below the resist layer) to be patterned.

After transferring the mask patterns of the reticle to the resist, the resist is developed and patterned by etching. Subsequently, the patterns of the resist are transferred to the layer below the patterned resist layer by anisotropic etching, for instance. Typically, the wafer exposure tool comprises a source for electromagnetic radiation (usually for UV or EUV radiation, or alternatively e-beam radiation or ion beam radiation) and further comprises a reticle stage and a wafer stage for receiving the wafer.

A wafer stepper is used in order to repeatedly expose plural portions of the wafer surface of a wafer by projecting the reticle. The wafer is stepped in lateral direction between successive exposure steps. Furthermore, a wafer scanning device is used in order to scan the wafer surface for distance measurement prior to exposing the wafer, thereby controlling and ensuring correct focus position of the wafer. To this end, a focus sensor is scanning the wafer surface (for instance by moving the wafer relative to the focus sensor), thereby propagating at least one focus sensor element or height level sensor across the wafer surface. For instance, the wafer surface can be scanned by scanning a plurality of parallel scanning line regions of the wafer surface one after the other.

In modern semiconductor manufacturing, the wafer stepper and the wafer scanning device may be combined to a wafer scanning/stepping device performing the stepwise movement of the wafer as well as the continuous scanning movements of the wafer.

In any case, however, a method step of scanning the wafer surface is performed for insuring correct position of the wafer surface relative to the wafer exposure system (that is relative to the optical exposure system including a radiation source and the reticle stage). To this end, the wafer stage must support the wafer in the optimum position (along three spatial directions) and in optimum orientation (along three different axes of rotation). Only in the optimum position and/or orientation of the wafer, the whole wafer surface may be positioned within the focus window of the wafer exposure device. Otherwise, portions of the wafer surface would be arranged out of the focus depth, thereby resulting in defective microelectronic structures on some of the integrated circuits fabricated on the wafer.

Current wafer exposure devices comprise a height level sensor device (that is a focus sensor) which comprises more than one focus sensor element. Instead, usually a plurality of height level sensors is provided within a sensor block of the height level sensor device, each individual height level sensor scanning a respective line-shaped region of the wafer surface when the sensor block is moved across the wafer surface. Since the diameter of the wafer surface is much larger than an active width of the sensor block (defined by the distance between a first and a last height level sensor thereof), the sensor block is repeatedly scanning over the wafer surface, after each scanning movement along a first direction the position of the sensor block along a second direction being changed. Accordingly, the number of scanning movements for scanning the whole wafer surface approximately corresponds to the wafer diameter divided by the active width of the sensor block.

The height level sensors of the focus sensor must be aligned with respect to one another in order to ensure correct measurement of the distance between the sensor block and the wafer surface. To this end, the plural height level sensors usually are adjusted, during manufacture of the wafer exposure system, relative to one another. However, when in use, the wafer exposure device may be subjected to deterioration of the alignment of the plural height level sensors. For instance, accelerated mechanical movements due to the stepping and/or scanning steps may gradually cause misalignments of the sensor block relative to a housing of the optical exposure system or misalignments of the individual height level sensors relative to one another. There are further influences (other than mechanical stress) which may cause effective misalignments of the height level sensors. For instance, the polarization of electromagnetic light beams used in each height level sensor may be altered, thereby influencing the magnitude of the measured distances or height values systematically. However, these and other influences normally are not actively observed by the tool manufacturer or by the user.

Accordingly, there exists the need for an improved wafer exposure device that ensures correct measurement of the wafer surface position irrespective of unfavorable influences on measuring precision of the individual height level sensors. Furthermore, there is a need for an improved method for more reliably measuring the relative position of a wafer in a wafer exposure device.

### SUMMARY OF THE INVENTION

In one embodiment, a wafer exposure device includes a wafer stage and an optical exposure system exposes a wafer on the wafer stage. A height level sensor device measures a distance of a wafer provided on the wafer stage from the optical exposure system. The height level sensor device includes a sensor block having a plurality of height level sensors arranged in fixed positions relative to one another, the plurality of sensors at least comprising a first height level sensor and a second height level sensor. The wafer exposure device controls the wafer stage and/or the sensor block to be moved relative to one another such that the sensor block is passing across the wafer along the first lateral direction, the sensor block having a fixed position along a second lateral direction during passing across the wafer. The wafer stage and the sensor block are further controlled to be moved such that the sensor block is repeatedly passing across the wafer along the first lateral direction, during each passing across the wafer the sensor block being disposed in another relative position along the second lateral direction. The wafer exposure device is further controlling the sensor block and the wafer stage to at least perform a first passing movement and a second passing movement along the first direction, the position of the first height level sensor along the second lateral direction during the second passing movement corresponding to the position of the second height level sensor along the second lateral direction during the first passing movement.

In another embodiment, a wafer exposure device includes a wafer stage and an optical exposure system for exposing a wafer on the wafer stage. A sensor block for measuring a distance to a wafer provided on the wafer stage, the sensor block comprising a plurality of height level sensors, each height level sensor measuring and outputting height level values. The wafer exposure device is comparing with one another the measured height level values outputted by respective height level sensors. The wafer exposure device is calculating individual sensor position offset values to be attributed to the individual height level sensors. The wafer exposure device is correcting the measured height level values outputted by the respective height level sensors using the calculated sensor position offset values of the respective height level sensor.

In another embodiment, a wafer exposure device includes a wafer stage, an optical exposure system for exposing a wafer on the wafer stage and a sensor block for measuring a distance to a wafer provided on the wafer stage. The sensor block comprises a plurality of height level sensors, each height level sensor measuring height level values. The wafer exposure device comprises height measurement correction means for comparing the measured height level values measured by the respective height level sensors. The height measurement correction means are calculating individual sensor position offset values attributed to the individual height level sensors. The height measurement correction means are correcting the measured height level values of the respective height level sensors using the calculated sensor position offset values of the respective height level sensor.

Another embodiment provides a method of measuring a distance to a wafer arranged in a wafer exposure device, the method comprising providing a wafer exposure device comprising a wafer stage, an optical exposure system and a height level sensor device for measuring a distance to a wafer provided on the wafer stage, the height level sensor device comprising a sensor block with a plurality of height level sensors, the plurality of height level sensors at least comprising a first and a second height level sensor. Arranging a wafer on the wafer stage. Performing a first scanning movement of the wafer stage and/or the sensor block relative to one another such that the sensor block is passing across the wafer along the first lateral direction, the wafer stage having a first position, relative to the sensor block, along a second lateral direction. Shifting the position of the wafer stage, relative to the sensor block along a second lateral direction, from the first position to a second position. Performing a second scanning movement of the wafer stage and/or the sensor block a second time relative to one another such that the sensor block is again passing across the wafer along the first lateral direction (x), the sensor block having the second position, relative to the sensor block, along the second lateral direction during the second scanning movement. The shift distance from the first position to the second position is chosen such that the position of the first height level sensor relative to the wafer stage, along the second direction, during the second scanning movement corresponds to the position of the second height level sensor relative to the wafer stage, along the second direction, during the first scanning movement.

Another embodiments includes a method of measuring a distance to a wafer arranged in a wafer exposure device, the method comprising providing a wafer exposure device comprising a wafer stage, an optical exposure system and a height level sensor device for measuring a distance to a wafer provided on the wafer stage, the height level sensor device comprising a sensor block with a plurality of height level sensors, the plurality of height level sensors at least comprising a first and a second height level sensor. A wafer is positioned on the wafer stage. A distance is measured between the wafer and the sensor block, the distance being measured separately by a plurality of height level sensors of the sensor block, each height level sensors thereby obtaining at least one height level value. Individual sensor position offset values attributed to the respective height level sensor are calculated, the calculated sensor position offset values indicating individual vertical offsets of the respective height level sensor relative to one another or relative to a reference height and correcting the measured height level values individually for each height level sensor using the calculated sensor position offset values.

### BRIEF DESCRIPTION OF THE DRAWINGS

The invention is hereinbelow described with reference to the Figures.

FIG. 1 is a schematical view of a wafer exposure device according to the invention;

FIG. 2 is a schematical view of a height level sensor device comprising plural height level sensors;

FIG. 3 is a schematical view of a height level sensor according to one embodiment of the invention;

FIG. 4 is a schematical view of a sensor block passing across a wafer surface;

FIG. 5 is a schematical view on a wafer surface as scanned in a conventional manner;

FIG. 6 schematically illustrates a method of scanning a wafer surface according to the invention;

FIG. 7 schematically illustrates measurement results of a method according to the invention;

FIG. 8 schematically illustrates an arrangement of scanning line regions used for obtaining the measurements of FIG. 9; and

FIG. 9 schematically illustrates further measurement results of a method according to the invention.

The following list of reference symbols can be used in conjunction with the figures:

| | | | |
|---|---|---|---|
| 1 | wafer exposure device | Ci | sensor position offset value |
| 2 | wafer stage | d | vertical distance |
| 3 | wafer chuck | H; Hi | height level value |
| 5 | wafer | HH | reference height |
| 5a | wafer surface | N | number of height level sensors |
| 5b | spot region | M; Mi; M0, . . . , M8 | height level sensor |
| 6 | semiconductor product | M1 | first height level sensor |
| 7 | emitter | M2 | second height level sensor |
| 8 | detector | P; P1, P2, . . . | passing movement |
| 10 | height level sensor device | P1 | first passing movement |
| 11 | radiation beam | P2 | second passing movement |
| 15 | sensor block | p | sensor pitch distance |
| 19 | illumination system | R; R1, R2, . . . | scanning line region |
| 20 | optical exposure system | s | shift distance |
| 21 | source | S; S1, . . . S9 | scanning line portion |
| 22 | optical lens system | SD; Sdi | standard deviation |
| 23 | reticle stage | x | first lateral direction |
| 24 | reticle | y | second lateral direction |
| 25 | storage unit | z | vertical direction |
| 30 | control unit | w | width of sensor block |
| A | wafer diameter | | |

### DETAILED DESCRIPTION OF ILLUSTRATIVE EMBODIMENTS

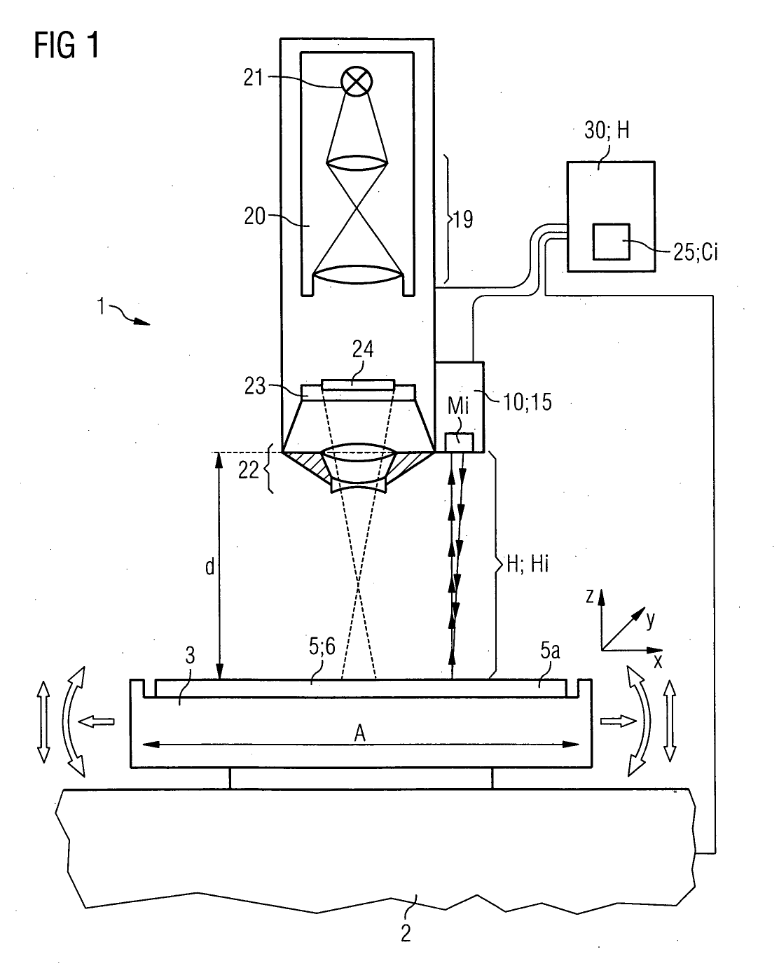

FIG. 1 illustrates a schematical view of a wafer exposure device 1. The wafer exposure device 1 preferably is a lithographic exposure device at least comprising a height level sensor device 10 and a wafer stage 2. The wafer exposure device may further include an optical exposure system 20 and a reticle stage 23 for receiving a reticle 24 to be projected on a portion of a wafer surface 5a of a wafer 5. The wafer stage 2 may comprise a wafer chuck 3 for receiving a wafer 5 thereon. The wafer chuck 3 may attract the bottom surface of the wafer by means of vacuum or very low pressure atmosphere in order to ensure safe contact of the wafer bottom surface with the contact main surface of the wafer chuck 3. The wafer stage 2 is capable of moving the wafer chuck 3 along a first lateral direction x, along a second lateral direction y and along a vertical direction z. Furthermore, the wafer stage is capable of varying and adjusting the orientation of the wafer chuck 3 as further indicated by curved arrows in FIG. 1. Appropriate mechanisms for moving the wafer chuck 3 are comprised in the wafer stage 2. These mechanisms serve to adjust the wafer position and/or orientation with respect to a height level sensor device 10 of a wafer exposure device 1 in order to arrange the complete wafer surface 5a within the optimum focus level plane. The optical exposure system 20 may comprise a source 21 of electromagnetic radiation, of e-beam radiation, or of an ion beam. In case of electromagnetic radiation, the source 21 in particular may emit ultraviolet light or extreme ultraviolet light. The source 21 and the optical lens system 22 are only schematically illustrated in FIG. 1. The wafer exposure device 1 may further comprise a reticle stage 23 for receiving and holding a reticle 24 in predefined position relative to at least one of the wafer stage 2 or the optical exposure system 20. The optical lens system 22 projects the mask patterns of the reticle 24 onto the wafer surface. The optical exposure system 20 may further comprise an illumination system 19 for illuminating the reticle 24.

Though in FIG. 1 the reticle 24 is illustrated to be a transmission mask, it is to be noted that future reticles might also be reflective reticles, in particular in case of extreme ultraviolet radiation. However, in this regard, FIG. 1 is only schematical irrespective of the actual type of reticle chosen (in particular regarding reflective or transmissive reticles).

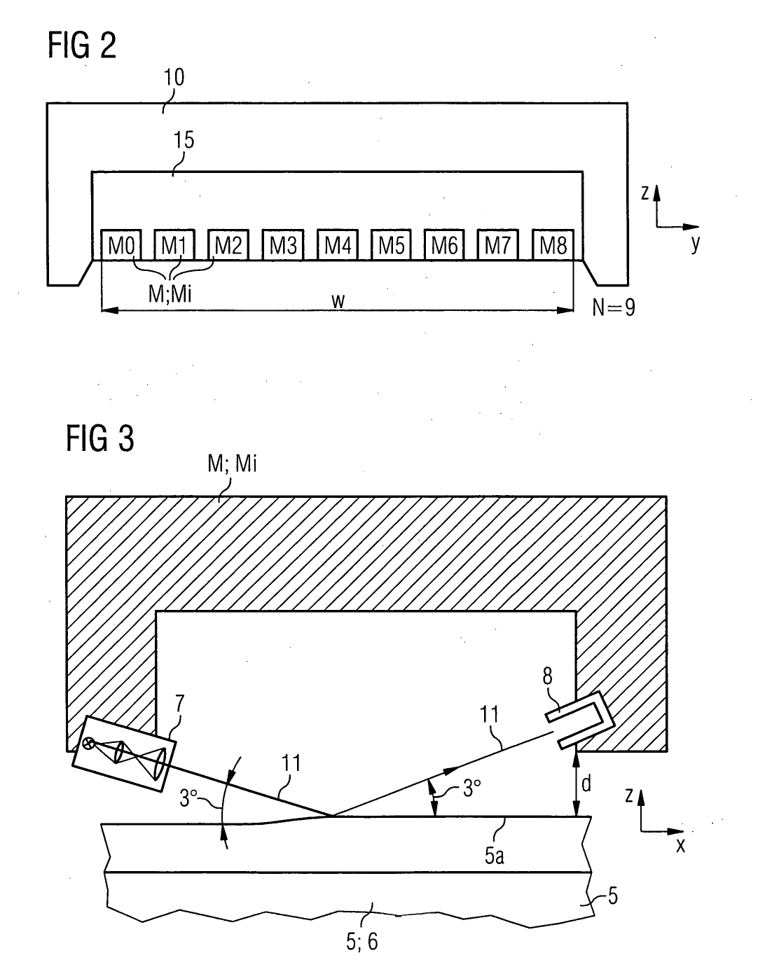

The wafer exposure device 1 further comprises a height level sensor device 10 that includes a plurality of height level sensors. The plural height level sensors are arranged in predefined positions relative to one another within a sensor block 15. The sensor block 15 or, respectively, the height level sensor device 10 (that is the focus sensor) is more detailedly illustrated in FIG. 2.

FIG. 2 illustrates a schematical view of a height level sensor device 10 comprising a plurality of height level sensors M. In the example of FIG. 2, 9 individual height level sensors Mi, that is M0, M1, M2, . . . , M8 are provided. The plural height level sensors Mi are to be arranged in aligned positions with respect to one another along the predefined vertical direction z. Furthermore, plural height level sensors Mi are arranged along a lateral direction y, for instance, so as to simultaneously scan a plurality of line-shaped regions (scanning line regions) of a wafer surface. Along the direction y along which the plural height level sensors Mi are arranged, the height level sensor device 10 (or the sensor block 15 comprising the plural sensors) has an effective width w. The effective width w corresponds to a width of a surface portion of a wafer surface which is scannable simultaneously by moving the sensor block 15 along a direction x from one edge of the substrate to another, opposed edge of the substrate. Preferably the plural height level sensors Mi are arranged in equidistant manner.

FIG. 3 illustrates a schematical view of a height level sensor according to one embodiment. The height level sensor M; Mi comprises a housing at which an emitter 7 and a detector 8 are mounted. The emitter 7 is emitting, for instance, a beam of light, preferably visible light, onto a portion of the substrate surface 5a of a wafer 5, of a resist layer 4 arranged on a wafer 5 or on any other semiconductor product 6. Accordingly, the wafer surface which distance from the height level sensor device 10 is measured, can commonly be a surface of any layer arranged on a semiconductor product 6, which at least comprises a wafer 5 and the layer (like the uppermost layer). Accordingly, the wafer surface 5a in the context of the present application is not limited to represent the upper surface of the wafer 5.

The radiation beam 11 emitted by the emitter 7, after passing through an optical system, is reflected by the substrate surface 5a. The reflected beam is directed to the detector 8 if the surface portion reflecting the beam has a predefined vertical position or height relative to the position of the height level sensor M. However, in case that the wafer surface 5a is arranged higher or lower than illustrated in FIG. 3, only a portion of light energy of the beam, if any, is relected into the detector. Accordingly, the detector 8 detects a lower intensity or no intensity at all. However, in case that the wafer surface is arranged in the predefined vertical position, the maximum energy or intensity of the beam is detected, thereby indicating ideal focus position of the wafer surface with respect to the height level sensor M and with respect to the optical exposure system 20. This allows measuring the vertical position of the wafer surface 5a relative to the focus sensor. Preferably, the radiation beam 11 is directed on the wafer surface 5a under a rather small angle between the surface and the direction of propagation. Preferably, the radiation beam 11 is an optical light beam of visible light. When comparing FIG. 3 with FIG. 2, FIG. 3 illustrates a cross-sectional view along another lateral direction x than the lateral direction y in FIG. 2. Accordingly, each height level sensor Mi of FIG. 2 is emitting a separate radiation beam 11 onto a wafer surface 5a in direction essentially parallel to direction x, for instance, which direction is perpendicular to the drawing plane of FIG. 2 and which corresponds to the horizontal direction in FIG. 3.

The height level sensor device 10 of FIGS. 2 and 3 is used to scan a wafer surface along the first lateral direction x. Prior to repeating the scanning movement on another line-shaped region of the wafer surface 5a along the first lateral direction x, the lateral position of the height level sensor device 10 along the second lateral direction y is changed in order to scan a different or at least partially different line-shaped or stripe-shaped region of the wafer surface 5a.

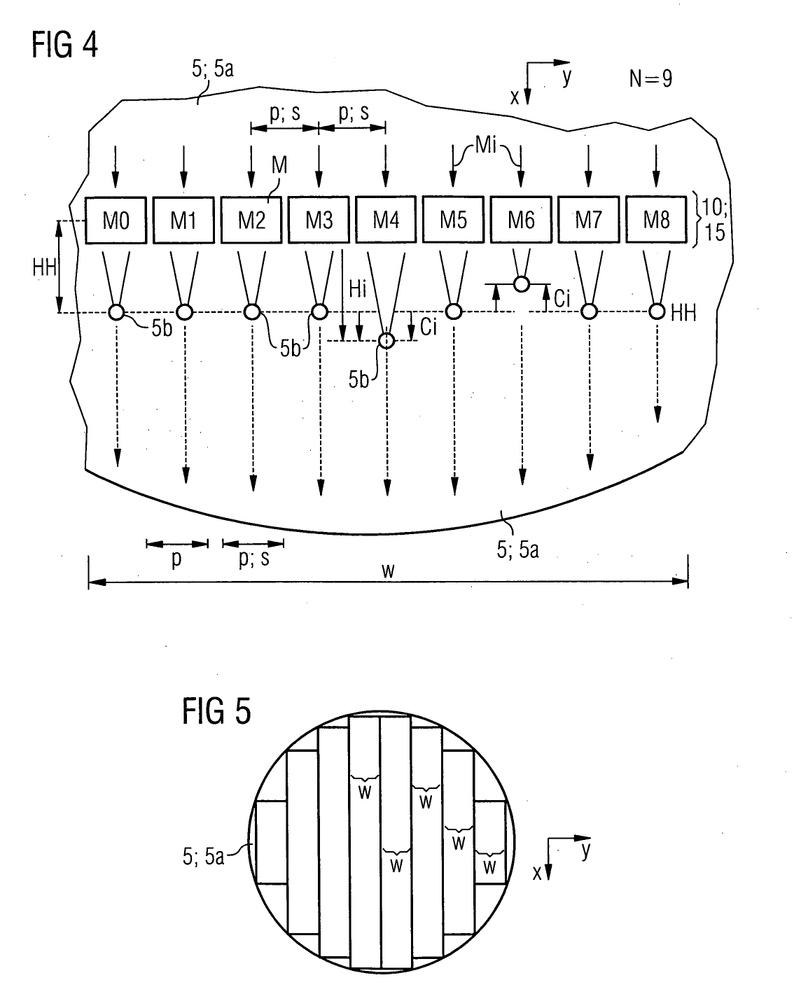

FIG. 4 schematically illustrates the movement of the sensor block 15 across a wafer surface 5a along the first direction x. The direction of movement is indicated by arrows directed downwards in FIG. 4. In the schematical top view of FIG. 4, the plural height level sensors M0 to M8 are illustrated, the height level sensors being arranged in equidistant manner along the second lateral direction y and being combinedly moved, when moving the height level sensor device 10 comprising the sensor block 15 across the substrate surface. FIG. 4 additionally illustrates spot regions 5b of the wafer surface 5a temporarily reflecting the beam of the respective height level sensor. Accordingly, the height level sensors Mi are spot sensors. When scanning the wafer surface, the spot is propagating across the line-shaped line region passed by the respective height level sensor Mi along the first lateral direction x. Due to the distance between the height level sensors, each height level sensor Mi is passing over a line-shaped substrate surface region having a width p, indicating the sensor pitch distance. Due to the equidistant arrangement of the height level sensors Mi along the second lateral direction y, a plurality of spot regions 5b arranged equidistant from one another is scanned at the same time, the position of the spot regions propagating along positive x-direction during one horizontal movement of the height level sensor device 10 across the wafer surface 5a.

FIG. 5 schematically illustrates a conventional method of scanning a wafer surface 5a. As illustrated in FIG. 5, the wafer surface 5a is scanned by moving the height level sensor device 10 as illustrated in FIG. 4, repeatedly across the substrate surface 5a, between successive movements along the first lateral direction x the lateral position of the height level sensor device 10 along the second lateral direction y being shifted by an amount corresponding to the effective width w of the sensor block 15 along the second lateral direction y. Accordingly, the plurality of lines or stripes each having the width w is scanned successively, thereby repeatedly passing over the substrate surface 5a along the first lateral direction x, each time the lateral position of the sensor block 15 along of the second lateral direction y being chosen differently.

Though this technique allows to efficiently scan the whole wafer surface, there is a risk that, in case of misaligned or incorrectly positioned height level sensors Mi within the sensor block, the precision of measuring the optimum position and orientation of the wafer surface 5a becomes worse. The decrease in precision of the height level measurement results from the circumstance that the misaligned height level sensors of the plurality of sensors cause an overall error in the measured height of the wafer surface 5a. In the context of the present invention, it is to be noted that the height of the wafer surface 5a more commonly is to be interpreted as the distance between the wafer surface and the height level sensor device and/or any other component of the wafer exposure tool, like the optical exposure system 20. However, in most cases this distance from the wafer surface is a vertical distance since wafers usually are supported horizontally onto a wafer chuck 3.

Some of the height level sensors Mi are misaligned or become misaligned during the use of the wafer exposure device 1, they produce systematical errors in the result of the height measurement since the respective height level sensors Mi, due to their incorrect position or other influences, measure a distance or height which is larger or smaller than the actual distance for height. Accordingly, this conventional method of scanning the wafer surface is disadvantageous.

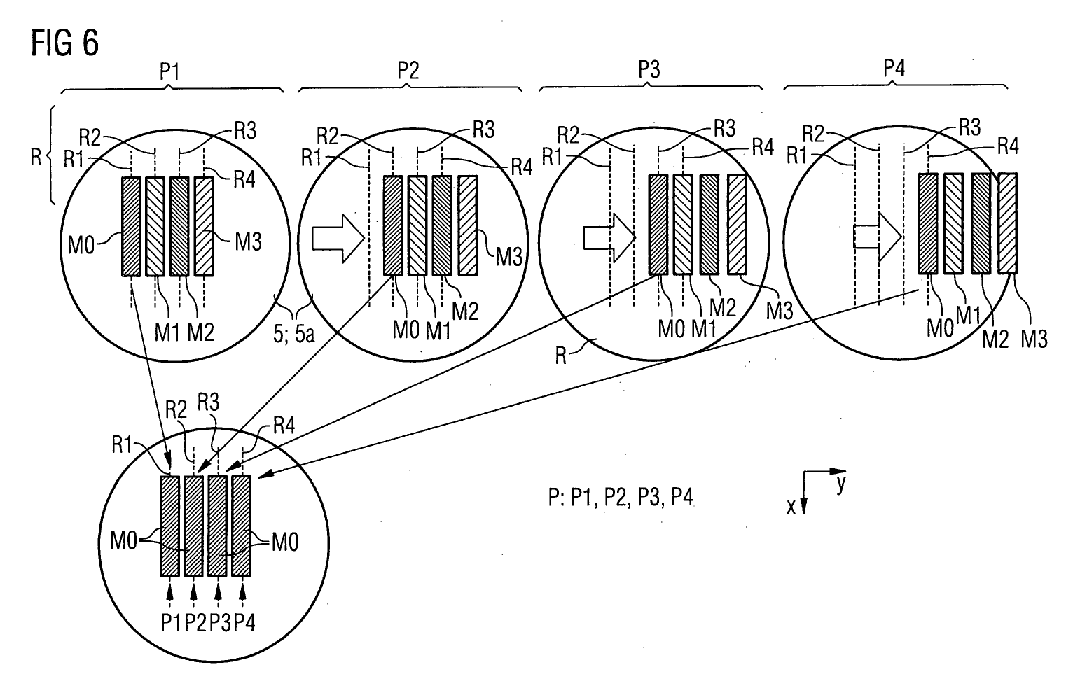

FIG. 6 schematically illustrates a method of scanning a wafer surface according to one embodiment of the invention. FIG. 6 in particular illustrates the positions of the sensor block of the wafer exposure device according to the invention relative to the wafer surface during plural scanning movements. In the top row of FIG. 6, four different scanning movements or passing movements P; P1, P2, P3, P4 are illustrated; during each passing movement P the sensor block being moved across the wafer surface along the first lateral direction x (vertical direction in FIG. 6). It is to be noted that in FIG. 6 the individual height level sensors M0, M1, M2, M3, . . . are illustrated as enlarged for clearer illustration. Furthermore, individual scanning line regions R1, R2, R3, R4 are also illustrated as enlarged and with an enlarged distance therebetween along the second lateral direction y (horizontal in FIG. 6). The enlarged illustration of the respective scanning line regions R and of the respective height level sensors M (compared to the diameter of the wafer surface 5a) only serves for clearer illustration of the shift of the y-position of the sensor block between successive scanning movements (called passing movements herein below) of the sensor block along x-direction across the wafer surface 5a.

During the first passing movement P1, the height level sensor device is arranged, along the second lateral direction y, relative to the wafer surface 5a such that the first height level sensor M0 is passing along the first lateral direction x over a first scanning line region R1. Accordingly, the second height level sensor M1 is scanning at the same time the second scanning line region R2. Simultaneously, the third height level sensor M2 is scanning a third scanning line region R3 and the fourth height level sensor M3 is scanning a fourth scanning line region R4. At the same time, further height level sensors will scan corresponding further scanning line regions. However, only four scanning line regions and height level sensors are illustrated in FIG. 6 for the first passing movement P1 in enlarged view for the purpose of explaining the invention. According to the invention, the sensor block 15 is shifted, after having performed the first passing movement P1, along the second lateral direction y by a shift amount which is smaller than the effective width w of the sensor block along the second lateral direction y. In particular, the sensor block is shifted by a shift amount preferably corresponding to the sensor pitch distance p between the height level sensors within the sensor block, thereby resulting in the arrangement illustrated in FIG. 6 for the second passing movement P2.

According to this subsequent, second passing movement, the first height level sensor M0 is now scanning the second scanning line region R2 which, during the first passing movement P1, has been scanned by another height level sensor of the sensor block 15 (that is by the second height level sensor M1). Accordingly, the same scanning line region R2 is scanned repeatedly, during each scanning another height level sensor Mi being used. Accordingly, the same distances between any spot region or scanning line region of the wafer surface 5a and the sensor block 6 is measured repeatedly with different sensors of the plurality of height level sensors, thereby obtaining more than one measurement result for each spot region or scanning line region on the wafer surface 5a. Thereby plural measurement results for the whole wafer surface 5a can be obtained; each measurement result being attributable to one respective individual height level sensor Mi of the sensor block 15. For instance, in FIG. 6 for the second passing movement P2, the first height level sensor M0 is passing over the second scanning line region R2. Simultaneously, the second height level sensor M1 is scanning the third scanning line region R3 and the third height level sensor M2 is scanning the fourth scanning line region R4 (whereas the fourth height level sensor M3 is scanning a further scanning line region not explicitly illustrated in the enlarged view of FIG. 6 for the second passing movement P2). Accordingly, the sensor block 15 comprising the height level sensors Mi has been shifted, between the passing movements P1 and P2, by an amount of shift, which is smaller than the effective width w of the sensor block and which, preferably, corresponds to the sensor pitch distance p or to a multiple of the sensor pitch distance p. Thereby the sensor block 15 is scanning, during the second passing movement P2, a wafer surface portion that partially overlaps with that wafer surface portion already scanned during the first passing movement P1. Accordingly, during the second passing movement P2 the height level sensor device 10 is positioned relative to the wafer stage 2 in such a way that other ones of the plural of height level sensors M; Mi, compared to the preceding passing movement P1, are now used to measure the distance to the same spot regions and scanning line regions of the wafer surface already scanned during the first passing movement P1.

Repeated scanning of a portion of the wafer surface with partially overlapping scanning regions may be continued further in order to preferably scan at least one scanning line region or spot region with any one of the height level sensors present in the height level sensor device 10. In particular, the repeated scanning may be continued in order to scan all scanning line regions (or spot regions) with one and the same height level sensor M (like the first sensor M0, for instance) across the whole wafer surface. In contrast therefore, during conventional scanning according to FIG. 5 only a small subset of all scanned scanning lines is scanned with a particular individual respective height level sensor since the scanned regions of successive passing movements do not overlap (due to the shift along y-direction which corresponds to the width w of the sensor block 15) as apparent from FIG. 5. According to FIG. 6, however, the amount of shift movements of the sensor block 15 relative to the wafer surface 5a (or, vice versa, of the wafer relative to the sensor block) can be chosen such that each scanning line region is scanned, at least once, by each of the same height level sensors of the sensor block. Furthermore, for at least two height level sensor M0, M1, measurement results for the whole wafer surface are obtained, these measurement results being attributable to this specific height level sensor M0, M1 since they have been measured using this height level sensor M0, M1.

Preferably, any one of the height level sensors M0 to M8 present in the sensor block 15 is used to scan the whole wafer surface 5a, thereby obtaining for each height level sensor Mi a scan result of the complete wafer surface 5a attributable to the respective height level sensor Mi used for the respective measurement.

For instance, according to FIG. 6, a third passing movement P3 is performed for which the sensor block is once again has been shifted along the second lateral direction y by a shift amount corresponding to the sensor pitch distance p, thereby resulting in scanning of the third scanning line region R3 by the first height level sensor M0 and scanning of the fourth scanning line region R4 by the second height level sensor M1. Simultaneously, the further height level sensors M2, M3, . . . are scanning further ones of the scanning line regions R. After the third passing movement P3 has been performed (for instance by beginning at the top portion of the wafer surface 5a as illustrated in FIG. 6 and finishing at the bottom portion thereof, the y-position of the height level sensor device 10 is shifted again in order to perform a fourth passing movement P4. During this passing movement, the first height level sensor M0 now scans the fourth scanning line region R4. By continuing this procedure, the whole waver surface 5a may be scanned, thereby obtaining the scan of the complete wafer surface 5a for each individual sensor of the plural height level sensors M0 to M8. Accordingly complete wafer surface 5a height scanning profiles can be attributed to any respective one of the height level sensors.

This allows to feedback the measurement results in order to calculate deviations of height measurement results of identical regions on the wafer surface 5a, but measured with different ones of the plural height level sensors. Thereby systematic influences caused by incorrect positions of individual height level sensors or by other misaligned or misadjusted elements within the individual height level sensors can be detected. Thereby systematic deviations of distance measurement results caused by the height level sensors themselves may be compensated. For instance, if a particular spot region 5b or scanning line region of the wafer surface 5a is measured to be arranged at a distance corresponding to a height level value H (H indicating a mean value or average value obtained from measurements using, successively, all height level sensors of sensor block 15), the measurement result Hi obtained using a particular height level sensor Mi will be different from the mean value H. By comparing the measurement results of the plural height level sensors for the whole wafer surface 5a scanned, correction values Ci may be calculated which represent a compensation for the difference between the actual measured value Hi using the respective height level sensor Mi and the mean value H (that is Ci=Hi−H). Accordingly, by subtracting the respective sensor-specific individual correction Ci calculated for the respective height level sensor Mi from the measurement result Hi obtained using this respective height level sensor Mi, the corrected measurement result H′=Hi−Ci is obtained which corresponds to the mean value H calculated using some or all height level sensors of the height level sensor device.

Accordingly, the invention allows to compensate systematic, sensor-specific offsets of the respective measurement results for each height level sensor of the sensor block 15, whereas conventionally such deviations are neither observed nor compensated. The invention provides a wafer exposure device which is able to scan wafer surface in such way that measurement results of different ones of the height level sensors of the sensor block may be compared to one another in order to detect any misalignments or incorrect positions of the height level sensors, for instance compared to a predefined reference height level value HH.

For instance, in FIG. 4 such misalignments of some of the height level sensors are illustrated schematically. Though FIG. 4 in general is a top view on a wafer surface 5a and is additionally illustrating the height level sensors M0 to M8, in the portion of FIG. 4 indicated by the arrow HH, shows a vertical distance between the arrangement of height level sensors M0 to M8 with respect to the wafer surface 5a is indicated. In particular, FIG. 4 shows a perspective view which illustrates that the distances between the respective spot regions 5b and the respective height level sensors Mi are indicating a vertical distances (rather than lateral distances), the vertical distance extending perpendicular to the first and the second lateral direction x, y. Usually, most of the height level sensors will be arranged in a position corresponding to a reference height HH. Accordingly, all height level sensors should be arranged in a flushing manner along a line extending along the second lateral direction y. However, some of the height level sensors may be misadjusted or misaligned or may comprise misaligned components. Thereby systematic deviations of the measurement results of the particular height level sensors occur. For instance, in FIG. 4 the fifth height level sensor M4 is misaligned or mismatched such that the measured distance Hi is larger than the reference height HH even in case that a wafer surface 5a, at the position of the spot region 5b of the fifth height level sensor M4, has the same distance from the sensor block as the first spot region 5b below the first height level sensor M0. Accordingly, a systematic error Ci occurs when measuring any distance to the wafer surface 5a using the fifth height level sensor M4. However, by comparing the measurement results for all height level sensors of the sensor block and by calculating a mean value, an individual, sensor-specific correction may be performed intrinsically by the wafer exposure device.

In FIG. 4, the seventh, height level sensor M6 further represents another mismatch leading to measurement results which indicate vertical distances to the wafer surface being too small compared to the actual distances. However, by scanning the complete wafer surface with each of the height level sensors, average measurement values H may be calculated which do not represent systematic influences of a particular height level sensor. The individual height level sensors are then calibrated internally by appropriate corrections. For instance, the correct height measurement values may be obtained according to H′=Hi−Ci (with Ci=Hi−H) so as to obtain a same, correct measurement result H′=H for each height level sensor. Accordingly, due to the internal calibration of the measurement results of individual height level sensors, the position of measuring the wafer position is increased.

To this end, the wafer exposure device 1 may further comprise a control unit 30 connected to the other components of the wafer exposure device as illustrated in FIG. 1. The control unit may additionally control the lateral movement of the wafer stage 2 with respect to the reticle stage 23 and to the optical exposure system 20. The control unit in particular allows lateral shift movements of the wafer stage between successive passing movements, the shift movements along the second direction y being chosen such that identical spot regions or scanning line regions on the wafer surface are measured using some or all height level sensors of the sensor block 15. The wafer exposure device of the invention need not necessarily scan the whole wafer surface (that is the plurality of all scanning line regions actually scanned) with each of the height level sensors. Instead, predefined scanning line regions may be scanned using, successively, all height level sensors whereas other scanning line regions are not scanned or are not scanned repeatedly. According to the invention, however, there is at least one region (like a scanning line region or a spot region, for instance) of the wafer surface which is scanned a first time using a first height level sensor and which is scanned a second time using another, second height level sensor.

In FIG. 1, the control unit 30 may be connected to the wafer stage 2, to the height level sensor device 10 and/or to the optical exposure system 20 of the wafer exposure device 1. The control unit 30 may further comprise a storage unit 25 for storing respective correction values Ci to be subtracted from a respective height measurement values Hi obtained by the respective height level sensor Mi of the sensor block 15.

Again referring to FIG. 6, the positions of the first height level sensor M0 during different passing movements P1, P2, P3, P4 of the wafer relative to the sensor block are combinedly illustrated at the bottom of FIG. 6. As apparent therefrom, the first height level sensor M0 is passing over the different scanning line regions R1, R2, R3, R4, thereby successively scanning the whole wafer surface. Thereby a height profile of the wafer surface measured using the first height level sensor M0 is obtained. In analoguous way, a further height profile or height map is obtained using the second height level sensor M1 for the measurement. Furthermore, preferably for each other height level sensor Mi a further height map or height profile of the complete wafer surface (that is of the plurality of all scanning line regions on the wafer surface) is obtained. The various height maps may be compared with one another and sensor-specific corrections Ci may be calculated, for instance by calculating deviations between the sensor-specific height values and the mean height values obtained from all height level sensors present in the sensor block.

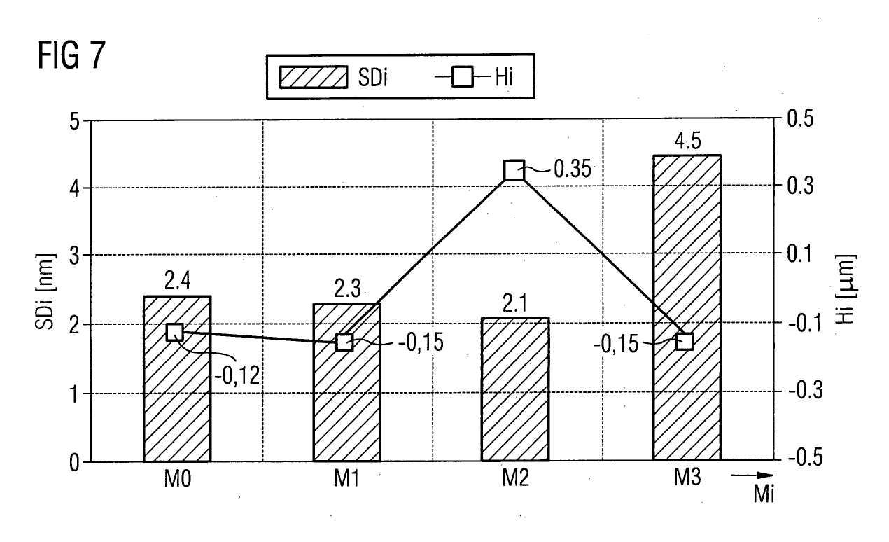

FIG. 7 illustrates measurement results of scanning a wafer surface using four height level sensors M0, M1, M2, M3. The height level sensors may correspond to those used according to FIG. 6. In FIG. 7, for each height level sensor Mi the respective average distance Hi is indicated. The average distance or mean distance in this context refers to scanning over the complete wafer surface that is scanning along all scanning line regions of FIG. 6. Thereby for each height level sensor Mi an average height value Hi is obtained, the average height corresponding to the average distance in vertical direction z, between the wafer surface and the respective height level sensor Mi (at the right side of FIG. 7, the numerical values of the average height value for the respective height level sensor is indicated in microns). However, on the numerical scale at the right side in FIG. 7, the measured distance minus an amount of a reference is indicated since the height of the individual sensor may be expressed by a sum of a reference height HH of the sensor block 15 above the wafer surface plus the offset of the respective individual height level sensor Mi. The reference height for instance may be a reference height HH corresponding to the height between the sensor block 15 or another component relative to the wafer surface). In ideal case, the average height (minus the reference height) should be 0 for all height level sensors, thereby indicating that each respective height level sensor is positioned in the reference height HH above the substrate surface. However, as apparent from the measurement results Hi for the height level sensors M0 and M1, the distance of these height level sensors to the substrate surface is somewhat smaller (concretely 0.12 and 0.15 microns smaller). The height level sensor M2 however is arranged in a larger distance compared to the reference height whereas the fourth height level sensor M1 is arranged closer to the substrate surface. Accordingly, the third height level sensor M2 is comparatively strongly misaligned with respect to the further height level sensors M0, M1 and M3 which are arranged at nearly the same distance from the substrate surface.

On the left side of FIG. 7 the standard deviation SDi for the measurement results measured across the wafer surface is indicated, i denoting the number of the respective height level sensor Mi. As apparent from FIG. 7, the standard deviation (in nanometers) for the first three height level sensors M0, M1, M2 is of the same order of magnitude whereas the standard deviation for the fourth height level sensor M3 is about twice as large. Accordingly, when measuring the height values across the wafer surface, the fourth height level sensor M3 is measuring with decreased portions compared to the further height level sensors M0 to M2. Since all height level sensors M0 to M3 have scanned the same wafer surface and in particular have scanned the same scanning line regions on the wafer surface, the fourth sensor M3 must be defective or at least an adjustment of the fourth height level sensor M3 is required since the fourth height level sensor M3, though being arranged at the same height as the sensors M0, M1, is measuring large deviations between the individual height values across the substrate surface.

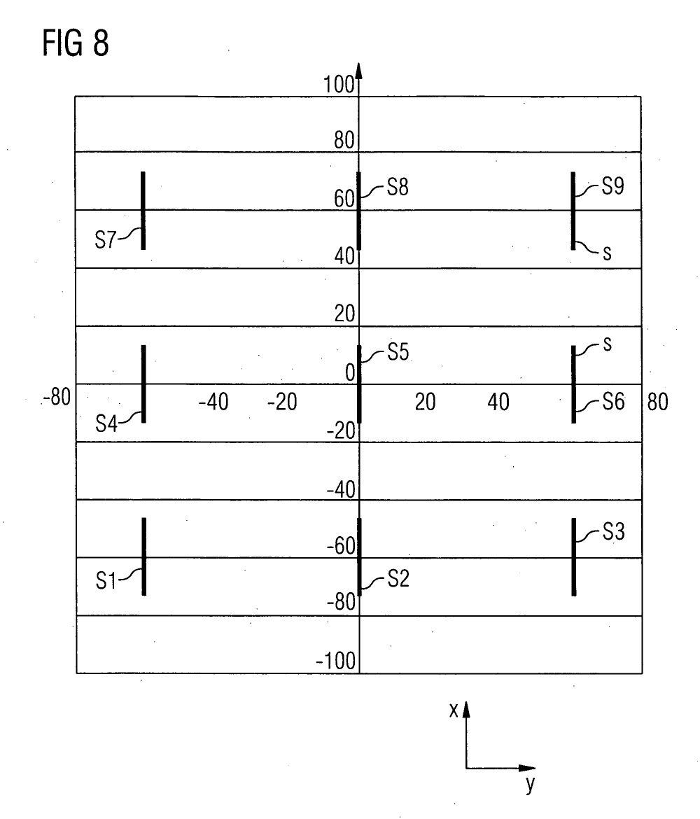

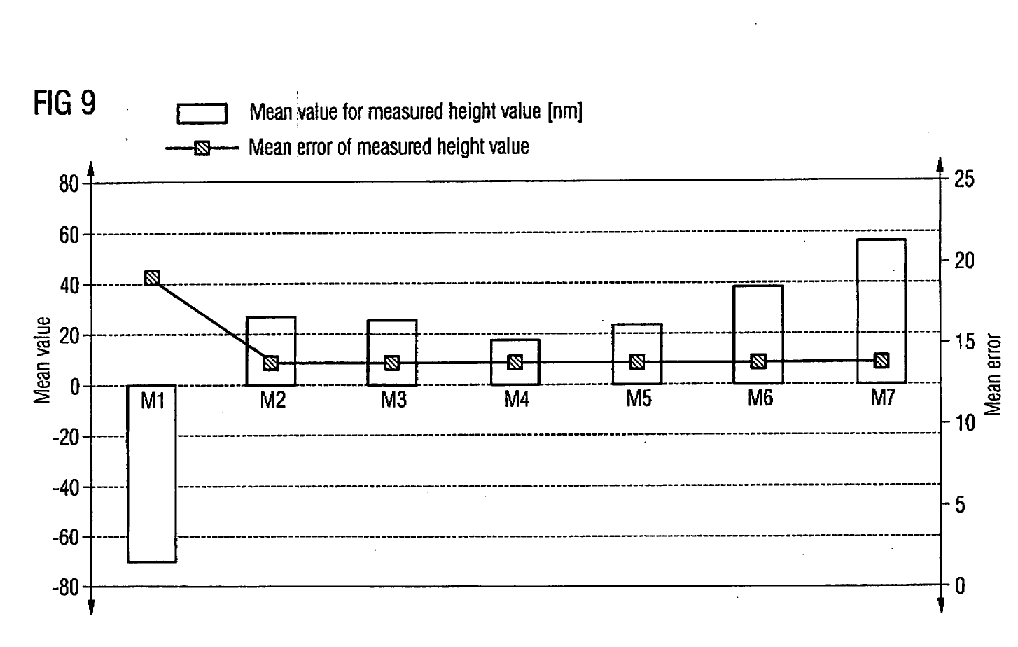

FIG. 8 illustrates an arrangement of scanning line portions used for obtaining the measurements results of FIG. 9. In FIG. 8, a square portion of a circular semiconductor surface is illustrated, a plurality of scanning line portions S; Si being identified on the wafer surface. In particular, at the center of the wafer surface along the second lateral direction y and at about 60% of the wafer diameter to positive and negative y-direction, respective scanning line portions are scanned. Furthermore, for each respective y-position on the wafer surface, the three respective scanning line portions are arranged at different positions along the first lateral direction x on the wafer surface. Accordingly, a matrix of 3×3 scanning line portions S1, S2, . . . , S9 is scanned. For scanning, the same wafer exposure tool comprising the sensor block of FIGS. 2 and 3 may be used, for instance. Accordingly, there are nine different height level sensors M0 to M9 usable for scanning the nine scanning line regions S1 to S9.

The result of scanning the scanning line portions Si of FIG. 8 is further illustrated in FIG. 9. According to FIG. 9, the height level sensors M0 and M8 have not been used for scanning the scanning line portions S. Instead, only the subset of height level sensors M1 to M7 has been used, each of these height level sensors scanning each of the scanning line portions S1 to S9. In FIG. 9, a mean value for the measured height value (in nanometers) is indicated on the left side of FIG. 9. The mean value is taken as an average over all nine scanning line portions S1 to S9 and, of course, as an average along the respective length of the scanning line portion S. As apparent from FIG. 9, for the height level sensor M1 the average height measured is about 70 nm smaller compared to the average distances corresponding to the reference height (indicated by “0” in FIG. 9) and about nearly 100 nm smaller compared to the average distances measured using the height level sensors M2 to M7. This indicates that the height level sensor M1 is strongly misaligned with respect to the position of the further height level sensors. Furthermore, when comparing the mean error of the measured height values indicated on the right side of FIG. 9, it is apparent that the mean error (or standard deviation) for the height level sensor M1 is the largest, compared to those of the further height level sensors M2 to M7. It is to be noted that, on the right scale in FIG. 9, the units are arbitrary units which only are proportional to the standard deviation.

From FIG. 9 it is further apparent that the height level sensors M7 and M6 are misaligned, to some extent, with respect to the further height level sensors M2 to M5. However, the measuring presicion of sensors M2 to M7 is of the same order of magnitude as for the sensors M2 to M5.

The present invention accordingly allows to improve the precision of measuring the distance to a wafer surface in a wafer exposure device and reduces the risk of producing semiconductor chips with defective integrated circuits.

1. A wafer exposure device comprising:
a wafer stage;
an optical exposure system for exposing a wafer on the wafer stage; and
a height level sensor device for measuring a distance of a wafer provided on the wafer stage from the optical exposure system,
wherein the height level sensor device comprises a sensor block comprising a plurality of height level sensors arranged in fixed positions relative to one another, the plurality of sensors at least comprising a first height level sensor and a second height level sensor,
wherein the wafer exposure device is operable to control the wafer stage and/or the sensor block to be moved relative to one another such that the sensor block passes across the wafer along the first lateral direction, the sensor block having a fixed position along a second lateral direction during passing across the wafer,
wherein the wafer exposure device is further operable to control the wafer stage and/or the sensor block to be moved such that the sensor block repeatedly passes across the wafer along the first lateral direction, during each pass across the wafer the sensor block being disposed in another relative position along the second lateral direction, and
wherein the wafer exposure device is further operable to control the sensor block and the wafer stage to at least perform a first passing movement and a second passing movement along the first direction, the position of the first height level sensor along the second lateral direction during the second passing movement corresponding to the position of the second height level sensor along the second lateral direction during the first passing movement.

2. The wafer exposure device of claim 1, wherein the wafer exposure device is operable to shift, between successive passing movements, the relative position of the sensor block and the wafer stage relative to one another along the second lateral direction by a shift distance that is smaller than a width of the sensor along the second lateral direction.

3. The wafer exposure device of claim 1, wherein the height level sensors are arranged in the sensor block at a predefined lateral sensor pitch distance from one another.

4. The wafer exposure device of claim 3, wherein the wafer exposure device is operable to shift, between successive passing movements, the relative position of the sensor block and the wafer stage relative to one another along the second lateral direction by a shift distance corresponding to the sensor pitch distance or to a multiple of the sensor pitch distance.

5. The wafer exposure device of claim 1, wherein the wafer exposure device is operable to control the height level sensor device and the wafer stage to perform a plurality of passing movements of the sensor block and the wafer stage relative to one another along the first lateral direction, each height level sensor of the sensor block scanning a scanning line region of a wafer surface of a wafer disposed on the wafer stage.

6. The wafer exposure device of claim 1, wherein the wafer exposure device is controllable to perform the plurality of passing movements each time when a new wafer to be exposed is scanned prior to exposure, wherein the number of passing movements performed per wafer to be exposed approximately corresponds to a wafer diameter divided through the sensor pitch distance.

7. The wafer exposure device of claim 6, wherein the number of passing movements performed per wafer to be exposed is independent from the number of height level sensors comprised in the sensor block.

8. The wafer exposure device of claim 6, wherein the wafer exposure device is controllable to perform the plurality of passing movements each time when a new wafer to be exposed is scanned prior to exposure, a plurality of individual, predefined scanning line regions on the wafer being scanned, wherein the number of passing movements corresponds to the number of predefined scanning line regions times the number of height level sensors comprised in the sensor block.

9. The wafer exposure device of claim 8, wherein the sensor block comprises a plurality of N height level sensors and wherein the wafer exposure device is operable to coordinate the shift between the sensor block and the wafer stage along the second lateral direction, between successive passing movements, in such a way that each predefined scanning line region is scanned by each of the N height level sensors of the sensor block.

10. The wafer exposure device of claim 8, wherein the sensor block comprises a plurality of N height level sensors and wherein the wafer exposure device is operable to coordinate the shift of the sensor block along the second lateral direction between successive passing movements in such a way that each predefined scanning line region is scanned by a subset of the plurality of N height level sensors of the sensor block.

11. The wafer exposure device of claim 1, wherein the height level sensors of the sensor block are arranged in equidistant manner along the second lateral direction within the sensor block.

12. The wafer exposure device of claim 1, wherein the wafer exposure device is controllable to measure vertical distances to a wafer provided on the wafer stage by respective height level sensors of the sensor block, for each height level sensor of the plurality of height level sensors or of a subset of the plurality of height level sensors the measured height level values being evaluated separately.

13. The wafer exposure device of claim 12, wherein the wafer exposure device is controllable to compare measured height level values obtained from respective height level sensors with one another and to calculate individual sensor position offset values attributed to the respective height level sensors, the calculated sensor position offset values indicating individual vertical offsets of the respective height level sensor relative to one another or relative to a reference height.

14. The wafer exposure device of claim 13, wherein the wafer exposure device is controllable to store the sensor position offset values in the storage unit, the stored sensor position offset values being attributed to each respective height level sensor individually.

15. The wafer exposure device of claim 14, wherein the wafer exposure device is controllable to correct future height level values measured with any of the height level sensors of the sensor block by the sensor position offset value attributed to the respective individual height level sensor.

16. The wafer exposure device of claim 15, wherein the wafer exposure device is controllable to subtract a respective sensor-specific sensor position offset value attributed to the respective height level sensor from each future height level value measured by the same respective height level sensor of the sensor block.

17. The wafer exposure device of claim 12, wherein the wafer exposure device comprises a control unit for controlling scanning of wafers on the wafer stage, for controlling relative movement of the height level sensor device and/or the wafer stage relative to one another and for controlling calculation and feedback of the sensor position offset values of the individual height level sensors.

18. The wafer exposure device of claim 1, wherein the height level sensors are spot sensors directing a radiation beam on a spot region on a wafer surface.

19. The wafer exposure device of claim 18, wherein the plurality of height level sensors of the sensor block are constructed to measure the respective vertical position of spot regions on a wafer surface, the spot regions simultaneously observed by the plural height level sensors of the sensor block being arranged equidistantly from one another at a pitch distance corresponding to the sensor pitch distance between the plurality of height level sensors in the sensor block.

20. The wafer exposure device of claim 1, wherein the height level sensor system comprising the sensor block is attached to the optical exposure system, the sensor block and the optical exposure system being arranged in a fixed position relative to one another.

21. The wafer exposure device of claim 20, wherein the wafer stage is moveable relative to the sensor block and to the optical exposure system.

22. The wafer exposure device of claim 1, wherein the wafer exposure device is operable to control the wafer stage to be moved such that the sensor block passes over the surface of a wafer provided on the wafer stage along the first lateral direction, plural passing movements being performed successively and the wafer stage being moved, between successive passing movements, along the second lateral direction for shifting the position of the wafer stage relative to the sensor block along the second lateral direction by a shift amount being smaller than the width of the sensor block.

23. The wafer exposure device of claim 1, wherein the optical exposure system comprises a source emitting electromagnetic radiation and further comprises an optical lens system.

24. The wafer exposure device of claim 1, wherein the optical exposure system comprises a reticle stage for receiving a reticle.

25. The wafer exposure device of claim 1, wherein the wafer stage comprises a wafer chuck for receiving a wafer or a semiconductor product comprising a wafer.

26. A wafer exposure device comprising:
a wafer stage;
an optical exposure system for exposing a wafer on the wafer stage; and
a sensor block for measuring a distance to a wafer provided on the wafer stage, the sensor block comprising a plurality of height level sensors, each height level sensor measuring and outputting height level values,
wherein the wafer exposure device is operable to compare with one another the measured height level values outputted by respective height level sensors,
wherein the wafer exposure device is operable to calculate individual sensor position offset values to be attributed to the individual height level sensors, and
wherein the wafer exposure device is operable to correct the measured height level values outputted by the respective height level sensors using the calculated sensor position offset values of the respective height level sensor.

27. The wafer exposure device of claim 26, wherein the wafer exposure device is operable to subtract the calculated sensor position offset values from the measured height level values measured by the respective height level sensor to which the respective sensor position offset value is attributed.

28. The wafer exposure device of claim 27, wherein the wafer exposure device is controllable to subtract the respective sensor-specific sensor position offset value from any future height level value measured by the same respective height level sensor.

29. The wafer exposure device of claim 26, wherein the wafer exposure device comprises a control unit for controlling calculation of the sensor position offset values and for correcting the measured sensor position offset value.

30. The wafer exposure device of claim 26, wherein the wafer exposure device comprises a storage unit for storing the sensor position offset values, each stored sensor position offset values being attributed to a respective height level sensor.

31. The wafer exposure device of claim 26, wherein the sensor position offset values are deviations of measured height level values from a reference height.

32. The wafer exposure device of claim 26, wherein the sensor position offset values are deviations of measured height level values of the respective height level sensor from a mean height level value obtained by evaluating measured height level values of all height level sensors of the sensor block.

33. The wafer exposure device of claim 26, wherein the wafer stage is moveable such that the height level sensors of the sensor block are simultaneously scanning a plurality of scanning line regions of a wafer surface of a wafer disposed on the wafer stage.

34. The wafer exposure device of claim 26, wherein the wafer exposure device is further operable to control the wafer stage such that the sensor block repeatedly scans a respective plurality of scanning line regions of a wafer surface, during each scanning operation other height level sensors of the sensor block being used for scanning those scanning line regions that have been scanned by further ones of the height level sensors of the sensor block during former scanning operations.

35. The wafer exposure device of claim 26, wherein the height level sensors are arranged in the sensor block at a predefined lateral sensor pitch distance from one another.

36. The wafer exposure device of claim 26, wherein the wafer exposure device is operable to shift, between successive scanning operations, the relative position of the wafer stage by a shift distance that is smaller than a width of the sensor.

37. The wafer exposure device of claim 26, wherein the wafer exposure device is operable to shift, between successive scanning operations, the relative position of the wafer stage by a shift distance corresponding to the sensor pitch distance or to a multiple of the sensor pitch distance in the sensor block.

38. The wafer exposure device of claim 26, wherein the moveable wafer stage is operable to be scanned by the sensor block along scanning line regions extending along a first lateral direction wherein the wafer stage is shifted, between successive scanning operations, in the direction of a second lateral direction.

39. The wafer exposure device of claim 26, wherein the height level sensors of the sensor block are operable to measure distances to a wafer surface of a wafer disposed on the wafer stage along a vertical direction.

40. The wafer exposure device of claim 26, wherein the wafer exposure device is operable to control the scanning operations such that during each scanning operations all height level sensors of the sensor block simultaneously scan a respective scanning line region on the wafer surface.

41. The wafer exposure device of claim 26, wherein the wafer exposure device is operable to control the scanning operations such that during each scanning operations a subset of all height level sensors of the sensor block are simultaneously scanning a respective scanning line region on the wafer surface.

42. The wafer exposure device of claim 41, wherein the height level sensors comprise spot sensors directing a radiation beam on spot regions of a wafer surface.

43. The wafer exposure device of claim 26, wherein the optical exposure system comprises a reticle stage for receiving a reticle, an optical lens system, the sensor block forming part of a height level sensor device arranged in a fixed position relative to at least one of the optical lens system and the reticle stage.

44. The wafer exposure device of claim 26, wherein the wafer stage comprises a wafer chuck for receiving a wafer or a semiconductor product comprising a wafer.

45. A wafer exposure device comprising:
a wafer stage;
an optical exposure system for exposing a wafer on the wafer stage;
a sensor block for measuring a distance to a wafer provided on the wafer stage, the sensor block comprising a plurality of height level sensors, each height level sensor measuring height level values; and
height measurement correction means for comparing the measured height level values measured by the respective height level sensors, wherein the height measurement correction means calculate individual sensor position offset values attributed to the individual height level sensors, and wherein the height measurement correction means correct the measured height level values of the respective height level sensors using the calculated sensor position offset values of the respective height level sensor.

46. The wafer exposure device of claim 45, wherein the height measurement correction means subtract the calculated sensor position offset values from the measured height level values measured by the respective height level sensor to which the respective sensor position offset value is attributed.

47. The wafer exposure device of claim 45, wherein the height measurement correction means comprise a control unit for controlling calculation of the sensor position offset values and for correcting the measured sensor position offset value.

48. The wafer exposure device of claim 45, wherein the height measurement correction means comprise a storage unit for storing the sensor position offset values, each stored sensor position offset values being attributed to a respective height level sensor.

49. The wafer exposure device of claim 45, wherein the sensor position offset values are deviations of measured height level values from a reference height.

50. The wafer exposure device of claim 45, wherein the sensor position offset values are deviations of measured height level values of the respective height level sensor from a mean height level value obtained by evaluating measured height level values of all height level sensors of the sensor block.

51. The wafer exposure device of claim 45, wherein the wafer stage is moveable such that the height level sensors of the sensor block simultaneously scan a plurality of scanning line regions of a wafer surface of a wafer disposed on the wafer stage.

52. The wafer exposure device of claim 45, wherein the wafer exposure device is controllable to shift, between successive scanning operations, the relative position of the wafer stage by a shift distance corresponding to the sensor pitch distance or to a multiple of the sensor pitch distance smaller than an effective width of the sensor block.

53. The wafer exposure device of claim 45, wherein the wafer exposure device is operable to control the scanning operation such that during each scanning operations all height level sensors of the sensor block are simultaneously scanning a respective scanning line region on the wafer surface.

54. The wafer exposure device of claim 45, wherein the wafer exposure device is operable to control the scanning operations such that during each scanning operation a subset of all height level sensors of the sensor block are simultaneously scanning a respective scanning line region on the wafer surface.

55. A method of measuring a distance to a wafer arranged in a wafer exposure device, the method comprising:
providing a wafer exposure device comprising a wafer stage, an optical exposure system and a height level sensor device for measuring a distance to a wafer provided on the wafer stage, the height level sensor device comprising a sensor block with a plurality of height level sensors, the plurality of height level sensors at least comprising a first and a second height level sensor;
arranging a wafer on the wafer stage;
performing a first scanning movement of the wafer stage and/or the sensor block relative to one another such that the sensor block passes across the wafer along the first lateral direction, the wafer stage having a first position, relative to the sensor block, along a second lateral direction;
shifting the position of the wafer stage, relative to the sensor block along a second lateral direction, from the first position to a second position; and
performing a second scanning movement of the wafer stage and/or the sensor block a second time relative to one another such that the sensor block again passes across the wafer along the first lateral direction, the sensor block having the second position, relative to the sensor block, along the second lateral direction during the second scanning movement,
wherein the shift distance from the first position to the second position is chosen such that the position of the first height level sensor relative to the wafer stage, along the second direction, during the second scanning movement corresponds to the position of the second height level sensor relative to the wafer stage, along the second direction, during the first scanning movement.

56. The method of claim 55, wherein a scanning line region on the wafer that has been scanned by the second height level sensor during the first scanning movement is subsequently scanned by the first height level sensor during the second scanning movement.

57. The method of claim 55, wherein the sensor block scans, during the first and second scanning movement, a wafer surface of the wafer along a first lateral direction and wherein the shift of the wafer stage relative to the sensor block between the first and second scanning movement is taken along a second direction.

58. The method of claim 55, wherein the wafer stage is shifted relative to the sensor block by a shift distance being smaller than a width of the sensor along the second lateral direction.

59. The method of claim 55, wherein the height level sensors are arranged in the sensor block at a predefined lateral sensor pitch distance from one another.

60. The method of claim 59, wherein the wafer stage is shifted relative to the sensor block by a shift distance corresponding to the sensor pitch distance or to a multiple of the sensor pitch distance.

61. The method of claim 55, wherein a plurality of scanning movements of the sensor block and the wafer stage relative to one another along the first lateral direction is performed successively, during each scanning movement each height level sensor of the sensor block scanning a respective scanning line region on a wafer surface.

62. The method of claim 61, wherein after each scanning movement of the plurality of scanning movements the position of the wafer stage, relative to the sensor block along a second lateral direction, is shifted.

63. The method of claim 61, wherein, between successive scanning movements, the position of the wafer stage relative to sensor block along the second lateral direction is shifted such that each scanning line region of the wafer surface, in the course of performing the plurality of scanning movements, is scanned once by each height level sensor of the plurality of height level sensors of the sensor block.

64. The method of claim 55, wherein, during each scanning movement, only a subset of the plurality of height level sensors of the sensor block scans the wafer surface.

65. The method of claim 64, wherein, between successive scanning movements, the position of the wafer stage relative to the sensor block along the second lateral direction is shifted such that each scanning line region of the wafer surface, in the course of performing the plurality of scanning movements, is scanned once by each height level sensor of the subset of height level sensors.

66. The method of claim 55, wherein vertical distances to the wafer provided on the wafer stage are measured by the height level sensors of the sensor block.

67. A method of measuring a distance to a wafer arranged in a wafer exposure device, the method comprising:
providing a wafer exposure device comprising a wafer stage, an optical exposure system and a height level sensor device for measuring a distance to a wafer provided on the wafer stage, the height level sensor device comprising a sensor block with a plurality of height level sensors, the plurality of height level sensors at least comprising a first and a second height level sensor; positioning a wafer on the wafer stage;
measuring a distance between the wafer and the sensor block, the distance being measured separately by a plurality of height level sensors of the sensor block, each height level sensor thereby obtaining at least one height level value;
calculating individual sensor position offset values attributed to the respective height level sensor, the calculated sensor position offset values indicating individual vertical offsets of the respective height level sensor relative to one another or relative to a reference height; and
correcting the measured height level values individually for each height level sensor using the calculated sensor position offset values.

68. The method of claim 67, wherein the sensor position offset values are subtracted from the measured height level values to obtain corrected height level values.

69. The method of claim 67, wherein deviations of measured height level values of the respective height level sensor from a mean height level value evaluated from measurements of all height level sensors are calculated when calculating the sensor position offset values.
